(19) United States
(12) Patent Application Publication
(10) Pub. No.: US 2021/0009797 A1
(43) Pub. Date: Jan. 14, 2021

(54) LIGHTWEIGHT PARTICLE FILLER MATERIAL

(71) Applicant: Schabel Polymer Technology, LLC, Westlake, OH (US)

(72) Inventors: Norman G. Schabel, JR., Rocky River, OH (US); David Schabel, Avon, OH (US); Doug Gorski, North Ridgeville, OH (US)

(21) Appl. No.: 16/923,469

(22) Filed: Jul. 8, 2020

Related U.S. Application Data
(60) Provisional application No. 62/871,447, filed on Jul. 8, 2019.

(51) Int. Cl. C08L 23/26; C09C 3/06; C09C 3/12; C09C 3/10; C08L 25/06; C08L 77/06; C08L 39/04; C08L 33/08; C08L 33/20; C08L 67/02; C08L 33/12; C08L 27/22; C08L 97/02

(52) U.S. Cl. CPC C08L 23/26; C08L 2207/066; C09C 3/12; C09C 3/10; C08L 25/06; C08L 77/06; C08L 39/04; C08L 33/08; C08L 33/20; C08L 67/02; C08L 33/12; C08L 27/22; C08L 97/02; C08L 2207/53; C08L 2207/062; C09C 3/063

(57) ABSTRACT

A lightweight particle composition includes a plurality of lightweight particles that are one of enclosed or loose. The plurality of lightweight particles include one of an inorganic or organic composition including a bulk density within a range from about 0.001 g/cc to about 1.5 g/cc, and a particle size within a range from about 0.01 microns to about 90 millimeters (mm). An interstitial void space between the plurality of lightweight particles includes a total of less than about 70% of a volume of the plurality of lightweight particles.

### CROSS-REFERENCE TO RELATED APPLICATIONS

The following application claims the benefit of priority to U.S. Provisional Application No. 62/871,447, titled “LIGHTWEIGHT PARTICLE FILLER MATERIAL” and filed on Jul. 8, 2019. The application is herein incorporated by reference.

### FIELD

The field of invention relates generally to lightweight materials used as fillers for various applications, such as bag or container fillers, void fillers, resin extenders, buoyancy support, composites, functional fillers, indicator applications, carriers and related systems.

### BACKGROUND

Lightweight particles used in filler applications have varying requirements based on the desired application. These include size specifications, density, shape, particle packing efficiency, material composition, strength, porosity, odor control, solubility, subsequent time release of a component substance, trigger release in the presence of an activation event. In many common filler applications, however, these factors and design aspects are not considered or maximized for the application. While various expanded, extruded, molded, formed, pressed, shredded, chopped, harvested, mined, printed, reacted, fused, stamped, die-cut, recycled or otherwise manufactured inorganic and organic materials, minerals, polymers, rubber, composites and similar materials have long been used as cushion or volume fill products, each of these examples has deficiencies due to limitations around weight, size, shape, porosity, durability, rigidity, composition, resilience, performance, reduced VOCs, functionality, performance and cost. As described herein, an improved lightweight filler particle(s) and related methods are disclosed.

### SUMMARY

The following presents a simplified summary of the disclosure to provide a basic understanding of some embodiments described in the detailed description.

In some embodiments, a lightweight particle composition comprises a plurality of lightweight particles that are one of enclosed, loose, or bonded. The plurality of lightweight particles comprise one of an inorganic or organic composition comprising a bulk density within a range from about 0.001 g/cc to about 1.5 g/cc. The plurality of lightweight particles comprise a particle size within a range from about 0.01 microns to about 90 millimeters (mm). An interstitial void space between the plurality of lightweight particles comprises a total of less than about 70% of a volume of the plurality of lightweight particles.

In some embodiments, the plurality of lightweight particles are modified or treated with one or more of a coating, a shell, or a substantially continuous outer layer.

In some embodiments, a treatment applied to the plurality of lightweight particles comprises a thickness within a range from about 0.001 mm to about 1 mm.

In some embodiments, the plurality of lightweight particles are coated with or incorporated into one or more of a resin, epoxy, urethane, polyurea, polyester, silicone, elastomeric, styrene-acrylic emulsion, styrene-butadiene emulsion, acrylic emulsion, latex emulsion, silane, siloxane, mineral, chemicals, fibers, graphene, powders, stearates, silicates, pigments, ethylene vinyl acetate, vinyl alcohol copolymer, vinyl acrylic emulsion polymer, acrylic copolymer, oleoresinous vehicles, cement, gypsum, or pozzolans.

In some embodiments, the plurality of lightweight particles comprise one or more of an expanded, extruded, molded, formed, pressed, shredded, chopped, harvested, mined, milled, printed, reacted, fused, stamped, die-cut, or recycled material.

In some embodiments, the plurality of lightweight particles comprise one or more of a base or a modified polyolefin, polystyrene, nylon, ABS, LDPE, HDPE, PVC, PVDC, acrylic, acrylonitrile based copolymer, agricultural biomass base material, a carbon material, graphene, a ceramic material, a silica aerogel material, an alumina material, copolymer and alloy systems, microspheres, rubber, an EPDM material, a polyamide, PET, PMMA, PMU, melamine, urea formaldehyde, polyvinylidene dichloride, hemp, sisal, rice hulls, oat hulls, ground corncobs, walnut shells, or a wood material.

In some embodiments, the plurality of lightweight particles comprise one or more of glass, foamed glass, mineral, ceramic, carbon, graphite, alumina, oxides, graphene, agricultural byproduct, biomass, rubber, synthetic or recycled materials.

In some embodiments, the plurality of lightweight particles comprise one or more of polymer pellets, polymer foam beads, crushed glass, foamed glass spheres, hollow glass microspheres, polymer microspheres, polymer capsules, polymer micro-balloons, or carbon-based pellets.

In some embodiments, the lightweight particle composition comprises a container or space comprising one or more walls that define an enclosed chamber, wherein the container comprises one or more of a bag, float, box, drum, tank, or a void within a wall, floor, ceiling, cavity, structure, or equipment housing.

In some embodiments, the plurality of lightweight particles can comprise free-flowing particles.

In some embodiments, the plurality of lightweight particles can be sprayed, pumped, or otherwise applied over, under, around, through, among, or on top of a space or surface.

In some embodiments, the plurality of lightweight particles comprises one or more of a rounded shape, a round shape, a sub-round shape, an angular shape, a sub-angular shape, a cylindrical shape, a pancake shape, an oblong shape, a trilobal shape, a tubular shape, a polygonal shape, a disc shape, a shard shape, a platelet shape, a lamellar shape, a regular crystalline shape, or an irregular crystalline shape.

In some embodiments, a lightweight particle composition comprises a plurality of lightweight particles comprising a bulk density within a range from about 0.001 g/cc to about 1.5 g/cc and a particle size within a range from about 0.01 microns to about 90 millimeters. The plurality of lightweight particles comprise one of an inorganic material, an organic material, or a first portion of the plurality of lightweight particles comprising an inorganic material and a second portion of the plurality of lightweight particles comprising an organic material. The plurality of lightweight particles further comprise one of a porous material, a non-porous material, or a third portion of the plurality of lightweight particles comprising a porous material and a fourth portion of the plurality of lightweight particles comprising a non-porous material. The plurality of lightweight particles comprise one or more of a coating, treatment, or modification incorporated into or applied to a surface or as part of a system of the plurality of lightweight particles that at least partially surrounds each of the plurality of lightweight particles, the coating comprising a thickness within a range from about 0.001 mm to about 1 mm, further wherein the coating is applied at a ratio of about 0.001% to about 50% by weight.

In some embodiments, methods of manufacturing a lightweight particle composition selecting a plurality of lightweight particles. The plurality of lightweight particles comprise a bulk density that is within a range from about 0.001 g/cc to about 1.5 g/cc, and a particle size is within a range from about 0.01 microns to about 90 millimeters (mm). The plurality of lightweight particles comprise one of an inorganic material, an organic material, or a first portion of the plurality of lightweight particles comprising an inorganic material and a second portion of the plurality of lightweight particles comprising an organic material. The plurality of lightweight particles further comprise one of a porous material, a non-porous material, or a third portion of the plurality of lightweight particles comprising a porous material and a fourth portion of the plurality of lightweight particles comprising a non-porous material. Methods comprise positioning the plurality of lightweight particles within a void space such that an interstitial void space between the plurality of lightweight particles comprises a total of less than about 70% of the volume of the space.

In some embodiments, methods further comprise applying one or more of a coating, treatment or modification to the plurality of lightweight particles.

In some embodiments, methods further comprise using the particles as an additive into a formulated system.

In some embodiments, methods further comprise applying one or more of a treatment, a modification, or a coating to the plurality of lightweight particles such that the plurality of lightweight particles comprise one or more of fire resistance, fire suppressant, anti-static, conductive, anti-microbial, anti-bacterial, anti-vermin, electronic tracker enabled, carrier for fertilizers, algicides, insecticides, weed killers, color, die or pigment, scent-modified, perfume-modified, flavor-modified, or reactance to one of more of temperature, pH, gases, chemicals, liquids, particles, infrared, dissolvable, infrared modified, magnetized, or electronic.

In some embodiments, the treatment, modification, or coating triggers or involves a release in the presence of an activation event or catalyzation event, wherein the activation event or catalyzation event comprises one or more of a petrochemical, peroxide, acid, base, temperature, chemical initiator, moisture, air oxidation, ultraviolet light, microwave, other radiation, pressure, force, or time at a time of manufacture, application, or later time to suit the conditions of use.

In some embodiments, the plurality of lightweight particles are selected to achieve one or more of a weight reduction, a cost reduction, or filling of a void without a loss of one or more of performance or appearance, and an R-value of the lightweight particle composition is within a range from about 0.1 to about 5. The plurality of lightweight particles are coated with or incorporated into one or more of a resin, epoxy, urethane, polyurea, polyester, silicone, elastomeric, styrene-acrylic emulsion, styrene-butadiene emulsion, acrylic emulsion, latex emulsion, silane, siloxane, mineral, chemicals, fibers, graphene, powders, stearates, silicates, pigments, ethylene vinyl acetate, vinyl alcohol copolymer, vinyl acrylic emulsion polymer, acrylic copolymer, oleoresinous vehicles, cement gypsum, or pozzolans.

In some embodiments, methods comprising mixing the plurality of lightweight particles with one or more of suspension agents, surfactants, dispersants, admixtures, or rheology modifiers.

In some embodiments, the space comprises an enclosed chamber within a container such that the plurality of lightweight particles are located within the container.

In some embodiments, the space comprises an open space such that the plurality of lightweight particles are used as carriers or loose-fill particles.

### BRIEF DESCRIPTION OF THE DRAWINGS

These and other features, embodiments and advantages are better understood when the following detailed description is read with reference to the accompanying drawings, in which:

FIG. 1 illustrates example embodiments of lightweight particles filling a void;

FIG. 2 illustrates example embodiments of lightweight particles filling a void;

FIG. 3 illustrates example embodiments of lightweight particles filling a void;

FIG. 4 illustrates example embodiments of a lightweight particle comprising a coating;

FIG. 5 illustrates various example embodiments of lightweight particles;

FIG. 6 illustrates a container comprising example embodiments of lightweight particles;

and

FIG. 7 illustrates a container comprising example embodiments of lightweight particles.

### DETAILED DESCRIPTION

Reference will now be made to exemplary embodiments, examples of which are illustrated in the accompanying drawings. It is to be understood that other embodiments may be utilized and structural and functional changes may be made without departing from the respective scope of the application. Moreover, features of the various embodiments may be combined or altered without departing from the scope of the application. As such, the following description is presented by way of illustration only and should not limit in any way the various alternatives and modifications that may be made to the illustrated embodiments and still be within the spirit and scope of the application.

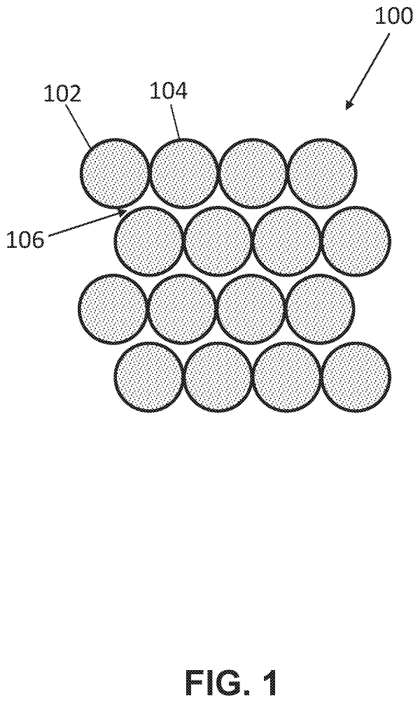

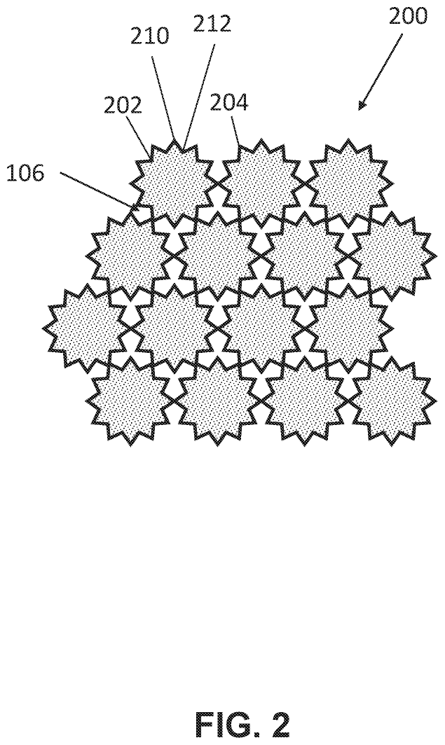

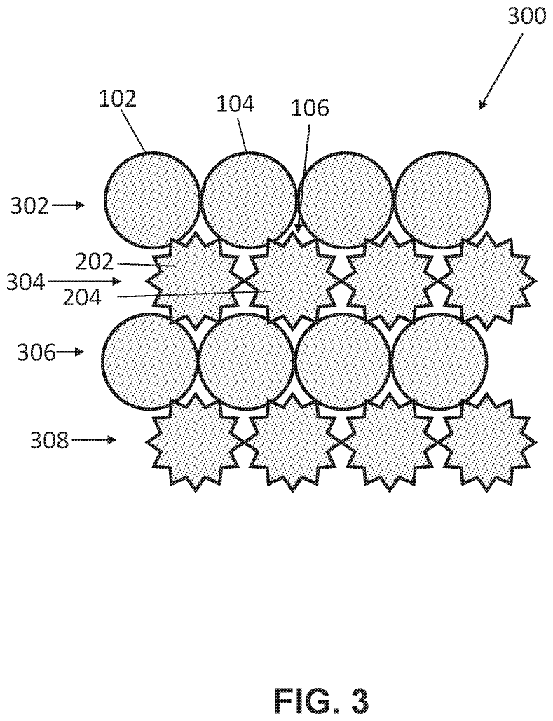

Referring to FIG. 1, an example of a lightweight particle composition 100 is illustrated. The lightweight particle composition 100 can comprise a plurality of lightweight particles that may be disposed within a space or an enclosed chamber. As used herein, the term “plurality” can comprise one or more different types (e.g., size, shape, material, coating application, etc.) of particles. For example, in some embodiments, the plurality of lightweight particles can comprise one type of particle, wherein the one type of particle has a substantially uniform size, shape, material, coating application. However, in some embodiments, the plurality of lightweight particles can comprise multiple types of particles, wherein the particles can comprise different sizes, shapes, materials, and/or coating applications, etc. FIG. 1 and FIG. 2 illustrate the plurality of lightweight particles as comprising a single type of particle (e.g., rounded/circular shape in FIG. 1, and with peaks/valleys in FIG. 2). FIG. 3 illustrates the plurality of lightweight particles as comprising multiple types of particles (e.g., some of the type from FIG. 1 and some of the type from FIG. 2). Other possible variations for the composition of the plurality of lightweight particles are envisioned. With reference to FIG. 1, in some embodiments, the plurality of lightweight particles may comprise a first lightweight particle 102, a second lightweight particle 104, etc. In some embodiments, the first lightweight particle 102, the second lightweight particle 104, other lightweight particles of the lightweight particle composition 100, etc. may be substantially similar or identical in size, shape, and characteristic (e.g., porosity, weight, material, surface coating, etc.). However, such a feature is not intended to be limiting, and in some embodiments, the lightweight particle composition 100 can comprise the plurality of lightweight particles in which a first portion of the lightweight particles are of a first size, first shape, and/or a first characteristic (e.g., porosity, weight, material, surface coating, etc.), a second portion of the lightweight particles are of a second size, second shape, and/or a second characteristic, etc.

In FIG. 1, in some embodiments, the plurality of lightweight particles (e.g., the first lightweight particle 102, the second lightweight particle 104) can comprise a rounded, substantially circular shape. The plurality of lightweight particles (e.g., the first lightweight particle 102, the second lightweight particle 104) can be positioned in close proximity to one another such that the plurality of lightweight particles (e.g., the first lightweight particle 102, the second lightweight particle 104) can be in contact with one another. In some embodiments, while the plurality of lightweight particles (e.g., the first lightweight particle 102, the second lightweight particle 104) can be in contact with each other, the lightweight particle composition 100 can comprise one or more voids 106 (e.g., interstitial void spaces, gaps, openings, etc.) that may be located between and adjacent to some of the lightweight particles.

In some embodiments, the lightweight particle composition 100 can provide effective cushioning of filled bags, such as shooting bags, containers, floats, buoys, formulated composites or systems, wall or floor cavities, and shapes with desired properties of weight, size, stability, rigidity, composition, particle packing, porosity, insulative value, strength and performance. The lightweight particle composition 100 can provide additional benefits as a filler for a bag and/or a container or a performance extender. For example, in some embodiments, the lightweight particle composition 100 can yield a weight reduction. For example, bulk densities of engineered low density particles (e.g., of the type used within the lightweight particle composition 100) can be within a range from about 0.2 pounds per cubic foot (pcf) to 90 pcf. Accordingly, the lightweight particle composition 100 can occupy the same amount of volume as ordinary fills but at a lower overall weight. In some embodiments, low density ranges can comprise a range from about 0.2 pcf to about 16 pcf, and/or within a range from about 16 pcf to about 40 pcf, and/or within a range from about 40 pcf to about 60 pcf, and/or within a range from about 60 pcf to about 90 pcf.

In addition, in some embodiments, a size, distribution, or composition of the lightweight particles can be adjusted. For example, by adjusting the size of the lightweight particles (e.g., a diameter in FIG. 1), particle size distribution of the lightweight particles (e.g., wherein some of the lightweight particles comprise a first size, other of the lightweight particles comprise a differing second size, etc.), and/or combining the lightweight particles with other sized low-density particles can improve particle packing and setup characteristics. For example, the size of each of the lightweight particles can comprise a range from about 0.001 millimeters (mm) to about 20 mm. In some embodiments, sizes of each of the lightweight particles can comprise a range from about 0.01 mm to about 2 mm. In some embodiments, sizes of each of the lightweight particles can comprise a range from about 0.05 mm to about 90 mm. In some embodiments, sizes of each of the lightweight particles can comprise a range from about 0.01 microns to about 90 millimeters. In some embodiments, sizes of each of the lightweight particles can comprise a range from about 1 mm to about 5 mm. In some embodiments, sizes of each of the lightweight particles can comprise a range from about 5 mm to about 10 mm. In some embodiments, sizes of each of the lightweight particles can comprise a range from about 10 mm to about 20 mm.

In some embodiments, the one or more voids 106 can form spaces (e.g., interstitial spaces) between each lightweight particle (e.g., 102, 104) when next to each other. By optimizing the size of the one or more voids 106 (e.g., in applications such as concrete mixes or composite systems), a strength of the overall composition can be improved and/or maximized. For example, the greater the packing of the lightweight particles (e.g., due to the size and shape of the lightweight particles), the less space that the one or more voids 106 can occupy, such that a tighter or more compressed mixture of the lightweight particles can be achieved. As such, compressive strength of the lightweight particle composition 100 can be improved. For example, in some embodiments, the one or more voids 106 can occupy a range from about 40% to about 50% of a total volume of the lightweight particle composition 100. In some embodiments, the one or more interstitial voids 106 can occupy a range from about 30% to about 40% of the total volume of the lightweight particle composition 100. In some embodiments, the one or more interstitial voids 106 can occupy a range from about 20% to about 30% of the total volume of the lightweight particle composition 100. In some embodiments, the one or more interstitial voids 106 can occupy a range from about 10% to about 20% of the total volume of the lightweight particle composition 100. In some embodiments, the one or more interstitial voids 106 can occupy a range that may be less than about 10% of the total volume of the lightweight particle composition 100. In some embodiments, the one or more interstitial voids 106 between the plurality of lightweight particles (e.g., 102, 104, 202, 204, 400, 502-518, 604, 606, 702, etc.) can comprise a total of less than about 70% of a volume of the plurality of lightweight particles (e.g., 102, 104, 202, 204, 400, 502-518, 604, 606, 702, etc.). In some embodiments, the one or more interstitial voids 106 between the plurality of lightweight particles (e.g., 102, 104, 202, 204, 400, 502-518, 604, 606, 702, etc.) can comprise a total of less than about 60% of a volume of the plurality of lightweight particles (e.g., 102, 104, 202, 204, 400, 502-518, 604, 606, 702, etc.). In some embodiments, the one or more interstitial voids 106 between the plurality of lightweight particles (e.g., 102, 104, 202, 204, 400, 502-518, 604, 606, 702, etc.) can comprise a total of less than about 50% of a volume of the plurality of lightweight particles (e.g., 102, 104, 202, 204, 400, 502-518, 604, 606, 702, etc.).

In some embodiments, the lightweight particle composition 100 can comprise a variety of particles shapes. For example, depending on the application, the lightweight particles can comprise one or more of a rounded shape, round or sub-round shape, angular or sub-angular shape, cylindrical shape, pancake shape, oblong shape, shard shape, platelet shape, lamellar shape, regular and/or irregular crystalline shape. In addition, other possible configurations and combinations are envisioned to improve performance for a given fill or extender application. For instance, in some fill applications, such as shooting bags, it may be beneficial for the lightweight particle(s) to “lock up” or have minimal movement when the bag is used as a platform, rest or stabilizer to enable a solid base. In other applications, such as in some composite formulas, a round or rounded shape can promote flow to application.

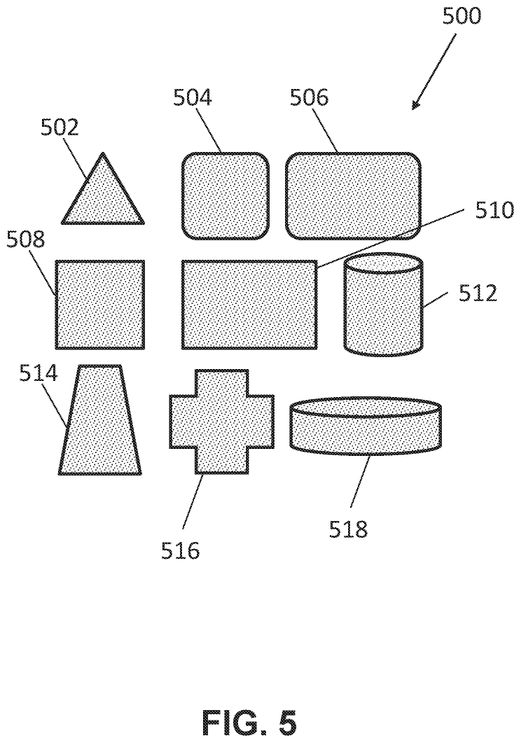

FIG. 5 illustrates several possible shapes of a lightweight particle composition 500. The following lightweight particles can be used separately or in addition to any of the other lightweight particles disclosed here, for example, any of the lightweight particles illustrated in FIGS. 1-7. For example, the lightweight particle composition 500 can comprise a triangularly shaped lightweight particle 502. In some embodiments, the lightweight particle composition 500 can comprise square shaped lightweight particle 504 with rounded corners. In some embodiments, the lightweight particle composition 500 can comprise a rectangularly shaped lightweight particle 506 with rounded corners. The lightweight particle composition 500 can comprise a square shaped lightweight particle 508 with non-rounded corners. The lightweight particle composition 500 can comprise a rectangularly shaped lightweight particle 510 with non-rounded corners. The lightweight particle composition 500 can comprise a cylindrically shaped lightweight particle 512. The lightweight particle composition 500 can comprise a trapezoidal shape 514. In some embodiments, the lightweight particle composition 500 can comprise a cross shape 516. In some embodiments, the lightweight particle composition 500 can comprise a cylindrically shaped lightweight particle 518 with a differing length than the particle 512.

Referring to FIG. 1, the lightweight particle composition 100 can comprise the plurality of lightweight particles (e.g., the first lightweight particle 102, the second lightweight particle 104, etc.) that comprise a round or circular shape. Referring to FIG. 2, a second lightweight particle composition 200 is illustrated. The second lightweight particle composition 200 may be similar in some respects to the lightweight particle composition 100, with the second lightweight particle composition 200 comprising a plurality of lightweight particles that differ in shape from the plurality of lightweight particles in FIG. 1. For example, the plurality of lightweight particles of FIG. 2 can comprise a first lightweight particle 202, a second lightweight particle 204, etc. The second lightweight particle composition 200 can comprise the one or more voids 106 that may be located between and adjacent to some of the lightweight particles (e.g., 202, 204, etc.). In some embodiments, the plurality of lightweight particles (e.g., 202, 204) can comprise a rounded shape with a non-constant cross-sectional size (e.g., diameter) at differing locations due to an undulating outer surface. For example, the first lightweight particle 202 can comprise an outer surface that comprises one or more peaks 210 and one or more valleys 212. The peaks 210 can be located between adjacent valleys 212 and, likewise, the valleys 212 can be located between adjacent peaks 210. In some embodiments, the cross-sectional size of the first lightweight particle 202 as measured at the peaks 210 can be greater than the cross-sectional size of the first lightweight particle 202 as measured at the valleys 212. The shape of the plurality of lightweight particles (e.g., 202, 204) can achieve several benefits. For example, in comparison to the plurality of lightweight particles of FIG. 1, the plurality of lightweight particles (e.g., 202, 204) can have reduced movement. In particular, due to the shape of the plurality of lightweight particles (e.g., 202, 204), the peak (e.g., 210) of one lightweight particle (e.g., 202) can be received within the valley (e.g., 212) of an adjacent lightweight particle (e.g., 204). Similarly, other peaks and valleys of adjacent lightweight particles can interlock (e.g., be received in one another), such that movement of one lightweight particle relative to adjacent lightweight particles may be limited. In contrast, in FIG. 1, the lightweight particle composition 100 with substantially rounded, circular lightweight particles can facilitate movement (e.g., or flow) between adjacent lightweight particles due to the smooth outer surface.

With reference to FIG. 3, in some embodiments, a third lightweight particle composition 300 can be similar in some respects to the lightweight particle composition 100 and to the second lightweight particle composition 200 of FIG. 2. For example, the third lightweight particle composition 300 can comprise a plurality of lightweight particles, wherein a first portion of the plurality of lightweight particles comprise the lightweight particles of the lightweight particle composition 100 (e.g., the first lightweight particle 102, the second lightweight particle 104, etc.), and a second portion of the plurality of lightweight particles comprise the lightweight particles of the second lightweight particle composition 200 (e.g., the first lightweight particle 202, the second lightweight particle 204, etc.). In some embodiments, the plurality of lightweight particles of the third lightweight particle composition 300 can be arranged in rows, for example, a first row 302, a second row 304, a third row 306, a fourth row 308, etc. In some embodiments, the shape of the lightweight particles may be non-constant and may differ from one row to another. For example, the first row 302 can comprise the rounded, circular lightweight particles of the lightweight particle composition 100. The second row 304, which may be adjacent to the first row 302, can comprise the non-circular lightweight particles of the second lightweight particle composition 200. The third row 306, which may be adjacent to the second row 304, can be substantially similar to the first row 302. The fourth row 308, which may be adjacent to the third row 306, can be substantially similar to the second row 304.

In some embodiments, the plurality of lightweight particles (e.g., 102, 104, 202, 204, 400, 502-518, 604, 606, 702, etc.) can comprise a reduced porosity, for example, little to no porosity, which can reduce or minimize any additional weight gain from absorbed moisture due to humidity, exposure to liquids (e.g., water, etc.), or binders (e.g., resins, acrylics, etc.). In some embodiments, other commonly used fillers may be mostly absorptive in nature and, when exposed to moisture or liquid resin may one or more of gain weight, harden, expand, and/or facilitate the growth of mold, mildew and fungus, and/or require more liquid or resin or binder in the system. These results may lead to undesirable outcomes. As such, the plurality of lightweight particles (e.g., 102, 104, 202, 204, 400, 502-518, 604, 606, 702, etc.) may avoid these undesirable outcomes.

In some embodiments, the plurality of lightweight particles (e.g., 102, 104, 202, 204, 400, 502-518, 604, 606, 702, etc.) can comprise an inherent compressive strength or ability to resist a compressive load that can be within a range that is between about 20 pounds per square inch (psi) to about several thousand psi, depending on the composition, size, shape, and density of the plurality of lightweight particles (e.g., 102, 104, 202, 204, 400, 502-518, 604, 606, 702, etc.). In some embodiments, the strength can be within a range from about 0.02 psi to about 20 psi. In some embodiments, the strength can be within a range from about 20 psi to about 200 psi. In some embodiments, the strength can be within a range from about 200 psi to about 2,000 psi. In some embodiments, the strength can be within a range from about 2,000 psi to about 20,000 psi. In some embodiments, the strength can be within a range from about 20,000 psi to about 100,000 psi, such that a top end range can be up to about 100,000 psi.

In some embodiments, the plurality of lightweight particles (e.g., 102, 104, 202, 204, 400, 502-518, 604, 606, 702, etc.) can comprise an inorganic material that may not act as a food source that attracts pests, rodents, or other unwanted creatures that have been known to eat through bags and other containers to reach the organic fills. In some embodiments, the plurality of lightweight particles (e.g., 102, 104, 202, 204, 400, 502-518, 604, 606, 702, etc.) can comprise minimal byproducts to reduce or minimize the creation of odors, toxicity, or distraction when used as fill materials in bags and/or containers and/or as part of a formulated system. Accordingly, the plurality of lightweight particles (e.g., 102, 104, 202, 204, 400, 502-518, 604, 606, 702, etc.) can comprise one of an inorganic or an organic composition. In some embodiments, the plurality of lightweight particles (e.g., 102, 104, 202, 204, 400, 502-518, 604, 606, 702, etc.) can comprise an inorganic and a non-porous or a porous material.

For example, in some embodiments, the plurality of lightweight particles (e.g., 102, 104, 202, 204, 400, 502-518, 604, 606, 702, etc.) can comprise one of: (i) an inorganic material; (ii) an organic material; or (iii) a first portion of the plurality of lightweight particles (e.g., 102, 104, 202, 204, 400, 502-518, 604, 606, 702, etc.) comprising an inorganic material and a second portion of the plurality of lightweight particles (e.g., 102, 104, 202, 204, 400, 502-518, 604, 606, 702, etc.) comprising an organic material. Accordingly, the plurality of lightweight particles (e.g., 102, 104, 202, 204, 400, 502-518, 604, 606, 702, etc.) can be all organic material (e.g., corresponding to (i)), all inorganic material (e.g., corresponding to (ii)); or a mixture of organic material and inorganic material (e.g., corresponding to (iii)). Likewise, in some embodiments, the plurality of lightweight particles (e.g., 102, 104, 202, 204, 400, 502-518, 604, 606, 702, etc.) can comprise one of: (i) a porous material; (ii) a non-porous material; or (iii) a third portion of the plurality of lightweight particles (e.g., 102, 104, 202, 204, 400, 502-518, 604, 606, 702, etc.) comprising a porous material and a fourth portion of the plurality of lightweight particles (e.g., 102, 104, 202, 204, 400, 502-518, 604, 606, 702, etc.) comprising a non-porous material. Accordingly, the plurality of lightweight particles (e.g., 102, 104, 202, 204, 400, 502-518, 604, 606, 702, etc.) can be all porous material (e.g., corresponding to (i)), all non-porous material (e.g., corresponding to (ii)); or a mixture of porous material and non-porous material (e.g., corresponding to (iii)).

In some embodiments, the plurality of lightweight particles (e.g., 102, 104, 202, 204, 400, 502-518, 604, 606, 702, etc.) can comprise a resin extender that can be compatible in the system to reduce the VOCs in the system. In some embodiments, the plurality of lightweight particles (e.g., 102, 104, 202, 204, 400, 502-518, 604, 606, 702, etc.) can provide sound (e.g., acoustical) and/or thermal insulation in varying degrees due to the composition, size, shape, density, and particle packing of the plurality of lightweight particles (e.g., 102, 104, 202, 204, 400, 502-518, 604, 606, 702, etc.). For example, thermal insulation value may be derived from having controlled void spaces (e.g., the one or more voids 106) with the interruption of the flow of air of different temperatures from one direction passing through a given space. In some embodiments, an R-value of the lightweight particle composition may be within a range from about 0 to about 5, or within a range from about 0.1 to about 5. In contrast, sound control or acoustical insulation may be achieved by having irregular voids in shape (e.g., the one or more voids 106) and less air voids which can act to transmit the sound.

In some embodiments, the plurality of lightweight particles (e.g., 102, 104, 202, 204, 400, 502-518, 604, 606, 702, etc.) can comprise a variety of different materials. For example, the plurality of lightweight particles (e.g., 102, 104, 202, 204, 400, 502-518, 604, 606, 702, etc.) can comprise one or more of expanded, extruded, molded, formed, pressed, shredded, chopped, harvested, mined, milled, printed, reacted, fused, stamped, die-cut, recycled or otherwise manufactured inorganic and organic materials, minerals, polymers, rubber, composites and similar materials, such as one or more of a base or a modified polyolefin, polystyrene, nylon, ABS, LDPE, HDPE, PVC, PVDC and other polymers and alloys, as well as glass, foamed glass, mineral, ceramic, carbon, graphite, alumina, oxides, graphene, agricultural byproduct or biomass, rubber and other synthetic or recycled materials and combinations thereof. In some embodiments, depending on specific applications, the selection of material characteristics for the plurality of lightweight particles (e.g., 102, 104, 202, 204, 400, 502-518, 604, 606, 702, etc.) can be optimized as needed, wherein the material characteristics can comprise particle density, strength, composition, particle packing, size, size distribution, shape, etc. In some embodiments, functional and appearance additives and/or coatings and/or modifications that can be incorporated into or as part of or onto the plurality of lightweight particles (e.g., 102, 104, 202, 204, 400, 502-518, 604, 606, 702, etc.) can comprise one or more of colorants, pigments, UV protection, anti-static agents, scent enhancers, odor reducers, anti-microbial, cooling and/or warming, anti-fungus, anti-bacterial, anti-vermin materials, coupling agents, adhesion promoters, coatings, reactive agents, adhesives, noise reduction, reinforcing materials or fibers, as well as fire retardants/smoke suppressants. Accordingly, in some embodiments, the plurality of lightweight particles (e.g., 102, 104, 202, 204, 400, 502-518, 604, 606, 702, etc.) can comprise one or more of a polyolefin, polystyrene, nylon, ABS, LDPE, HDPE, PVC, PVDC, acrylic, acrylonitrile based copolymer, agricultural biomass base material, a carbon material, graphene, a ceramic material, a silica aerogel material, an alumina material, copolymer and alloy systems, microspheres, rubber, an EPDM material, a polyamide, PET, PMMA, PMU, melamine, urea formaldehyde, polyvinylidene dichloride, hemp, sisal, rice hulls, oat hulls, ground corncobs, walnut shells, or a wood material. In some embodiments, the plurality of lightweight particles (e.g., 102, 104, 202, 204, 400, 502-518, 604, 606, 702, etc.) can comprise one or more of polymer pellets, polymer foam beads, crushed glass, foamed glass spheres, hollow glass microspheres, polymer microspheres, polymer capsules, polymer micro-balloons, or carbon-based pellets.

In some embodiments, the plurality of lightweight particles (e.g., 102, 104, 202, 204, 400, 502-518, 604, 606, 702, etc.) can be surface treated or coated to improve performance characteristics. Methods of manufacturing lightweight particle compositions 100, 200, 300, 500, 700 can comprise applying the coating to the plurality of lightweight particles (e.g., 102, 104, 202, 204, 400, 502-518, 604, 606, 702, etc.). For example, methods are envisioned to diminish, mitigate, or inhibit the inherent porosity, absorption, static or organic matter or FR properties or the ability to incorporate a system of the particles to achieve other desired performance characteristics. For example, the method can comprise modifying the base particle (e.g., 102, 104, 202, 204, 400, 502-518, 604, 606, 702, etc.) either by adjusting the composition, inserting a material into the lightweight particles (e.g., 102, 104, 202, 204, 400, 502-518, 604, 606, 702, etc.), imparting an additive into or among the lightweight particles (e.g., 102, 104, 202, 204, 400, 502-518, 604, 606, 702, etc.), or treating or coating the exterior of the lightweight particles (e.g., 102, 104, 202, 204, 400, 502-518, 604, 606, 702, etc.). in some embodiments, this modification can occur prior to, during, or after production. In some embodiments, an additive may be added or included with the lightweight particles (e.g., 102, 104, 202, 204, 400, 502-518, 604, 606, 702, etc.) prior to or during use. In some embodiments, a coating may be applied as either a liquid (e.g., water based, solvent based, etc.), gel, resin, epoxy or powder, and either mechanically, heat, air, chemically, UV, or otherwise bonded to and/or cured to the lightweight particles (e.g., 102, 104, 202, 204, 400, 502-518, 604, 606, 702, etc.). In some embodiments, the lightweight particles (e.g., 102, 104, 202, 204, 400, 502-518, 604, 606, 702, etc.) may be coated or incorporated with an admixture, such as a stearate, prior to use as loose particles ready to use as is, and/or the particles may be preblended with a coating ready to be pumped, sprayed, poured or applied into a void or cavity or container or bag, and/or the particles may be pumped, poured, sprayed or placed into a space and then a coating or binder may be pumped, poured, sprayed or placed on top of or among the particles to bind them together, or the coating may be activated or catalyzed via some means, such as a UV-cure, once they are properly in place to maintain their structure and bind them together. A coating is typically applied at a ratio of about 1% to about 5% by weight and typically 80%+ percent of the particles would be coated, and the common thickness layer is a result of desired performance, but typically less than about 1 mm, typically 1-3 mils. In some embodiments, the coating can be applied at a ratio of 0.001% to about 50% by weight. As used herein, the term ‘loose’ can mean that the lightweight particles (e.g., 102, 104, 202, 204, 400, 502-518, 604, 606, 702, etc.) are not located within a container or an enclosed space, but, rather, are located within an open and unbounded area such as a lawn, a ground surface, etc. Accordingly, the space can comprise an open space such that the plurality f lightweight particles can be used as carriers or loose-fill particles.

In some embodiments, the lightweight particles (e.g., 102, 104, 202, 204, 400, 502-518, 604, 606, 702, etc.) are one of enclosed (e.g., within the chamber), loose, or bonded (e.g., adhered to one another or to another material). In any of the embodiments disclosed herein, the lightweight particles (e.g., 102, 104, 202, 204, 400, 502-518, 604, 606, 702, etc.) can be applied or placed as part of a system, for example, a liquid or solid system. In some embodiments, the plurality of lightweight particles (e.g., 102, 104, 202, 204, 400, 502-518, 604, 606, 702, etc.) can comprise one or more of a coating, treatment, or modification incorporated into or applied to a surface (e.g., of the lightweight particles) or as part of a system. Accordingly, in some embodiments, methods can comprise using the plurality of lightweight particles (e.g., 102, 104, 202, 204, 400, 502-518, 604, 606, 702, etc.) as an additive into a formulated system.

It will be appreciated that the application of the coating (e.g., or treatment, surface modification, encapsulation, etc.) to the plurality of lightweight particles (e.g., 102, 104, 202, 204, 400, 502-518, 604, 606, 702, etc.) is optional and not required. For example, in some embodiments, all of the plurality of lightweight particles (e.g., 102, 104, 202, 204, 400, 502-518, 604, 606, 702, etc.) in the lightweight particle composition 100, 200, 300, 500, 700 may comprise one or more of the coating, treatment, surface modification, encapsulation, etc. However, in some embodiments, some of the plurality of lightweight particles (e.g., 102, 104, 202, 204, 400, 502-518, 604, 606, 702, etc.) but less than all of the plurality of lightweight particles (e.g., 102, 104, 202, 204, 400, 502-518, 604, 606, 702, etc.) in the lightweight particle composition 100, 200, 300, 500, 700 may comprise one or more of the coating, treatment, surface modification, encapsulation, etc. In some embodiments, none of the plurality of lightweight particles (e.g., 102, 104, 202, 204, 400, 502-518, 604, 606, 702, etc.) in the lightweight particle composition 100, 200, 300, 500, 700 comprise the coating, treatment, surface modification, encapsulation, etc.

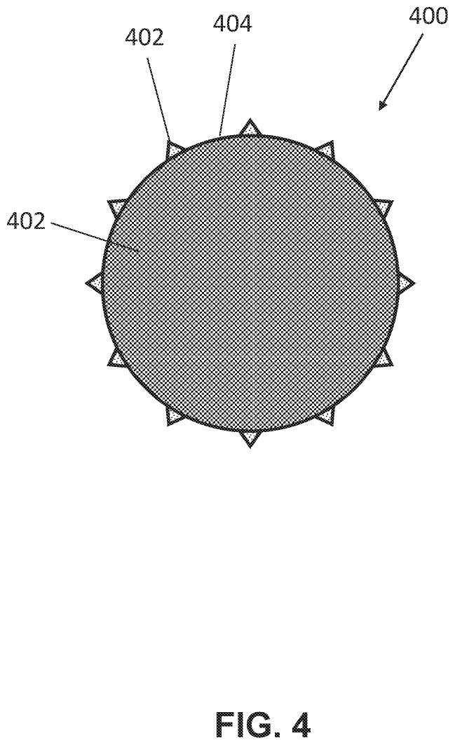

Referring to FIG. 4, an example of a lightweight particle 400 is illustrated. The lightweight particle 400 can comprise a body 402 with an outer surface 404. Though the body 402 is illustrated as comprising a rounded, circular shape, other possible shapes are envisioned. In some embodiments, the lightweight particle 400 can comprise a coating, wherein the coating is illustrated as a layer 402 positioned on the outer surface 404. In some embodiments, a space (e.g., a void, a gap, etc.) may be located between adjacent layers 402, such that the lightweight particle 400 can comprise a plurality of layers 402. In some embodiments, the space may not be present, such that the layer 402 extends continuously around the body 402 in contact with the outer surface 404. In some embodiments, the coating (e.g., the layer 402) can be applied to the surface 404 of the plurality of lightweight particles (e.g., 102, 104, 202, 204, 400, 502-518, 604, 606, 702, etc.) and can at least partially surround each of the plurality of lightweight particles (e.g., 102, 104, 202, 204, 400, 502-518, 604, 606, 702, etc.), with the coating (e.g., the layer 402) comprising a thickness within a range from about 0.001 mm to about 1 mm. Accordingly, in some embodiments, the plurality of lightweight particles (e.g., 102, 104, 202, 204, 400, 502-518, 604, 606, 702, etc.) may be modified or treated with one or more of a coating, a shell, or a substantially continuous outer layer. In some embodiments, a treatment (e.g., a coating, a layer, etc.) may be applied to the plurality of lightweight particles (e.g., 102, 104, 202, 204, 400, 502-518, 604, 606, 702, etc.) and may comprise a thickness within a range from about 0.001 mm to about 1 mm.

In some embodiments, various types of dry, powder, liquid, or resinous coatings can be applied to the lightweight particles (e.g., 102, 104, 202, 204, 400, 502-518, 604, 606, 702, etc.). Examples of the coatings can comprise one or more of resins, epoxies, urethane (including aliphatics), polyurea, polyester, silicone, elastomerics, styrene-acrylic emulsion, styrene-butadiene emulsion, acrylic emulsion, latex emulsion, silane, siloxane, ethylene vinyl acetate, vinyl alcohol copolymer, vinyl acrylic emulsion polymer, acrylic copolymers, alkyd applications, enamel, vinyl plastisol, oleoresinous vehicles, along with various fibers, chemicals, minerals, such as calcium carbonate, clay, talc, pigments, metallic stearates, metallic silicates, carbon, graphite, graphene, additives or powder coatings. Some or all of these materials may be used and may comprise a coating depending on the characteristics and performance needed of the lightweight particles (e.g., 102, 104, 202, 204, 400, 502-518, 604, 606, 702, etc.). In some embodiments, a coating may be applied before processing the material, during the processing of the material and/or after the material has been produced. In some embodiments, a coating may not be applied at all. The coating may be mechanically, chemically and/or otherwise imparted into and/or onto or as part of the lightweight particles (e.g., 102, 104, 202, 204, 400, 502-518, 604, 606, 702, etc.). An example of a particle modification may be calcium stearate.

It will be appreciated that, in some embodiments, the coatings may serve various purposes to improve the functionality of the lightweight particles (e.g., 102, 104, 202, 204, 400, 502-518, 604, 606, 702, etc.). For example, the coating(s) can one or more of diminish, mitigate or inhibit the inherent porosity or absorption of the lightweight particles (e.g., 102, 104, 202, 204, 400, 502-518, 604, 606, 702, etc.), improve the compressive strength and durability of the lightweight particles (e.g., 102, 104, 202, 204, 400, 502-518, 604, 606, 702, etc.), counteract and seal the negative aspects of any organic materials to render them inorganic or inert, subsequent time release of a component substance, trigger release in the presence of an activation event counteract, mitigate or minimize any potential unwanted odor or to provide a desired scent, smell or aroma of the lightweight particles (e.g., 102, 104, 202, 204, 400, 502-518, 604, 606, 702, etc.), improve insulative properties, provide electrostatic dissipation or conductivity, adjust or minimize inherent magnetic or static charge, provide anti-microbial, anti-fungal, anti-bacterial, anti-mildew and anti-vermin properties, reduce noise of the particles when jostled in the vessel, provide a desired color, container or package, improve bonding or incorporation into a formulated system, and/or to impart or improve fire retardant/smoke suppressant properties. In some embodiments, an additional benefit of the coating of the lightweight particles (e.g., 102, 104, 202, 204, 400, 502-518, 604, 606, 702, etc.) may be to improve their ability to either bond to each other or to other materials or to be more free-flowing in the finished product matrix. As used herein, an activation event can comprise, for example, a temperature, chemical initiator (e.g., acid or base or petrochemical or peroxide), moisture, air oxidation, ultraviolet light, microwave, other radiation, pressure, force, or time. In some embodiments, the lightweight particles (e.g., 102, 104, 202, 204, 400, 502-518, 604, 606, 702, etc.) can be activated or catalyzed at the time of manufacture, application, or at a later time to suit the conditions of use. In some embodiments, methods can comprise applying one or more of a treatment, a modification, or a coating to the plurality of lightweight particles such that the plurality of lightweight particles comprise one or more of fire resistance, fire suppressant, anti-static, conductive, anti-microbial, anti-bacterial, anti-vermin, electronic tracker enabled, carrier for fertilizers, algicides, insecticides, weed killers, color, die or pigment, scent-modified, perfume-modified, flavor-modified, or reactance to one of more of temperature, pH, gases, chemicals, liquids, particles, infrared, dissolvable, infrared modified, magnetized, or electronic. Accordingly, in some embodiments, the treatment, modification, or coating can trigger or involve a release in the presence of an activation event or catalyzation event, wherein the activation event or catalyzation event comprises one or more of a petrochemical, peroxide, acid, base, temperature, chemical initiator, moisture, air oxidation, ultraviolet light, microwave, other radiation, pressure, force, or time at a time of manufacture, application, or later time to suit the conditions of use.

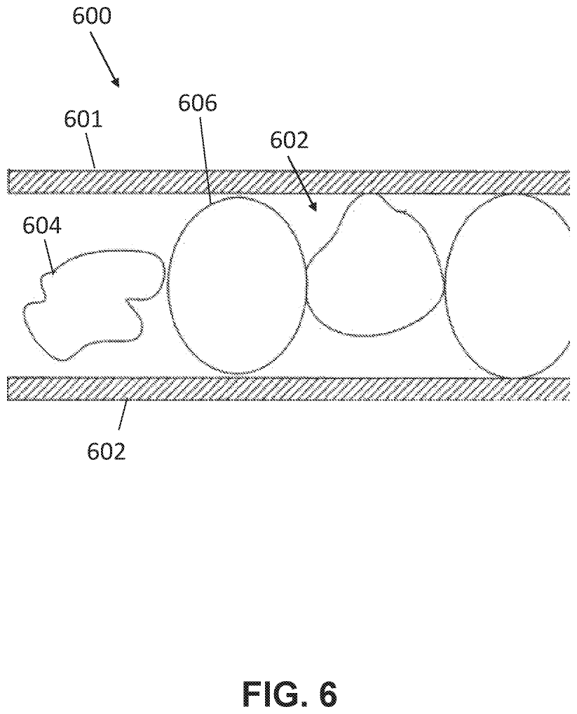

In some embodiments, there may be various uses of the lightweight particle compositions 100, 200, 300, 500, 700. For example, the lightweight particle compositions 100, 200, 300, 500, 700 can be used as fill or as extenders. Referring to FIG. 6, a container 600 (e.g., or space) is illustrated comprising one or more walls 601, 602 that define an enclosed chamber 603. In some embodiments, the container 600 can comprise any number of structures or devices within which lightweight particles 604, 606 can be positioned. For example, the container 600 can comprise any of the following: cushion, pad, pillow, package or container fill materials, including but not limited to: pre-formed and/or covered seat cushions, chairs, mattresses, armrests, kicking pads, fitness mats, martial arts targets, fitness vests, safety vests, flotation vests, packaging, industrial and/or commercial explosives, protective shipping and dunnage, cargo and ocean-going ship ballast and hull liner fill, gap and space fillers, wall voids and cavities, floor voids and cavities, ceilings, structures, equipment housing, containers or other compounded material formulations, composite system fill and extender, such as epoxy resin systems, concrete, urethane concrete, gypsum concrete, grouts, stuffing in toys, stuffing in flotation devices, floating docks, nautical buoys, seaplane floats, fill for therapy and medical pillows, casts and recovery pads, bean bags, shooting or hunting bags, pillows, rests and targets. Accordingly, in some embodiments, the lightweight particle composition 100, 200, 300, 500, 700 can be used in the following applications: dunnage (e.g., as an inexpensive material that is used to stabilize, secure, and/or protect cargo during transportation), electronic tracking applications, or high build coatings (e.g., coating materials that are formulated so that a single application can cover surfaces with relatively thick films that do not sag or run). In some embodiments, the container 600 can comprise one or more of a bag, float, box, drum, or tank.

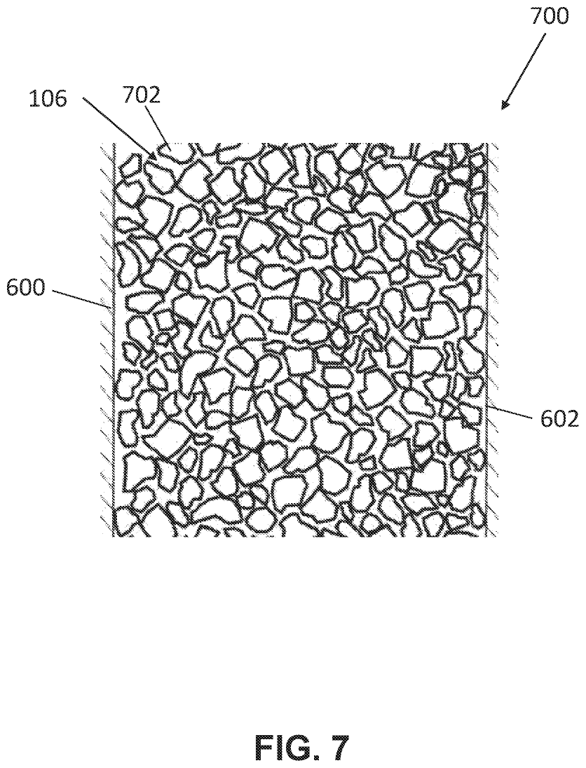

As illustrated in FIG. 7, in some embodiments, a lightweight particle composition 700 can comprise the container 600 with lightweight particles 702 positioned within the enclosed chamber surrounded by the one or more walls 601, 602. Accordingly, in some embodiments, methods of manufacturing lightweight particle compositions 100, 200, 300, 500, 700 can comprise providing the container 600 comprising one or more walls 601, 602, that define the enclosed chamber 603. Methods can comprise selecting the plurality of lightweight particles 102, 104, 202, 204, 400, 502-518, 604, 606, 702, etc. and positioning the plurality of lightweight particles 102, 104, 202, 204, 400, 502-518, 604, 606, 702, etc. within a space or the enclosed chamber 603. By selecting the plurality of lightweight particles 102, 104, 202, 204, 400, 502-518, 604, 606, 702, a particular type, shape, composition, characteristic, etc. of the plurality of lightweight particles 102, 104, 202, 204, 400, 502-518, 604, 606, 702 may be selected that can match a desired application. In some embodiments, prior to positioning, the plurality of lightweight particles 102, 104, 202, 204, 400, 502-518, 604, 606, 702, etc. can be delivered, for example, to a customer, a warehouse, etc. The positioning can then be done after the delivery. However, in other embodiments, the positioning can be done prior to delivery. In some embodiments, methods can comprise providing a space, and positioning the plurality of lightweight particles 102, 104, 202, 204, 400, 502-518, 604, 606, 702 within the space. As used here, in some embodiments, the space may comprise the enclosed chamber within the container (e.g., surrounded by the one or more walls 601, 602). However, in some embodiments, the space may comprise an open area that may not be constrained by walls (e.g., for example, an outdoor setting, etc.). In some embodiments, methods can comprise mixing the plurality of lightweight particles 102, 104, 202, 204, 400, 502-518, 604, 606, 702 with one or more of suspension agents, surfactants, functional chemicals, curing agents, dispersants, admixtures, or rheology modifiers. One or more of the suspension agents, surfactants, functional chemicals, curing agents, dispersants, admixtures, or rheology modifiers can be applicable in applications in polymer emulsion systems.

In some embodiments, the lightweight particle compositions 100, 200, 300, 500, 700 can comprise polyolefin particles (e.g., the lightweight particles 102, 104, 202, 204, 400, 502-518, 604, 606, 702, etc.) with a cylindrical shape within a range from about 0.5 mm to about 5 mm in diameter and within a range from about 0.5 mm to about 7 mm in length with an average bulk density within a range from about 0.2 pcf to about 20 pcf. Such a composition can provide excellent rigidity. In some embodiments, the plurality of lightweight particles (e.g., 102, 104, 202, 204, 400, 502-518, 604, 606, 702, etc.) can comprise a bulk density that is within a range from about 0.001 grams/cubic centimeter (g/cc) to about 1.5 g/cc. In some embodiments, the plurality of lightweight particles 102, 104, 202, 204, 400, 502-518, 604, 606, 702 can be disposed within the enclosed chamber 603 of FIG. 6.

In some embodiments, the lightweight particle compositions 100, 200, 300, 500, 700 can comprise PVDC micro particles (e.g., the lightweight particles 102, 104, 202, 204, 400, 502-518, 604, 606, 702, etc.) with an oblong shape with an average size within a range from about 0.001 mm to about 2 mm with an average bulk density within a range from about 0.5 pcf to about 20 pcf. Such a composition can provide weight savings, FR performance, strength, reduced VOC, improved particle packing while still providing excellent rigidity.

In some embodiments, the lightweight particle compositions 100, 200, 300, 500, 700 can comprise PVC particles (e.g., the lightweight particles 102, 104, 202, 204, 400, 502-518, 604, 606, 702, etc.) with a rounded or pancake shape with an average size within a range from about 0.1 mm to about 6 mm with an average bulk density within a range from about 30 pcf to about 60 pcf. Such a composition can provide weight savings, FR performance, strength, reduced VOC, insulation, and improved particle packing, while still providing excellent rigidity.

In some embodiments, the lightweight particle compositions 100, 200, 300, 500, 700 can comprise expanded polystyrene particles (e.g., the lightweight particles 102, 104, 202, 204, 400, 502-518, 604, 606, 702, etc.) with a rounded shape and an average size within a range from about 0.1 mm to about 6 mm with an average bulk density within a range from about 0.3 pcf to about 8 pcf. Such a composition can provide weight savings, FR performance, reduced VOC, insulation and improved particle packing, while still providing excellent rigidity.

In some embodiments, the lightweight particle compositions 100, 200, 300, 500, 700 can comprise glass-based particles (e.g., the lightweight particles 102, 104, 202, 204, 400, 502-518, 604, 606, 702, etc.) with a rounded shape with an average size within a range from about 0.01 mm to about 8 mm with an average bulk density within a range from about 8 pcf to about 40 pcf. Such a composition can provide excellent weight savings, FR performance, particle packing, insulation, compressive strength and resiliency. As used herein, the resiliency can be achieved, at least in part, from the lightweight particles 102, 104, 202, 204, 400, 502-518, 604, 606, 702. For example, the lightweight particles 102, 104, 202, 204, 400, 502-518, 604, 606, 702 can be resilient and can bounce back, deform, or recover in response to a pressure or stress that is imparted upon the lightweight particles 102, 104, 202, 204, 400, 502-518, 604, 606, 702. In this way, the lightweight particles 102, 104, 202, 204, 400, 502-518, 604, 606, 702 can avoid brittle failure and shattering, which can result in abrasiveness.

In some embodiments, the lightweight particle compositions 100, 200, 300, 500, 700 can comprise rubber (e.g., the lightweight particles 102, 104, 202, 204, 400, 502-518, 604, 606, 702, etc.), such as EPDM, with an angular or subangular shape with an average size within a range from about 0.01 mm to about 8 mm with an average bulk density within a range from about 20 pcf to about 50 pcf. Such a composition can provide excellent weight savings, FR performance, particle packing, insulation, compressive strength and resiliency.

In some embodiments, the lightweight particle compositions 100, 200, 300, 500, 700 can comprise carbon particles (e.g., the lightweight particles 102, 104, 202, 204, 400, 502-518, 604, 606, 702, etc.) with round or sub-round shape with an average size within a range from about 0.01 mm to about 8 mm with an average bulk density within a range from about 10 pcf to about 70 pcf. Such a composition can provide excellent weight savings, FR performance, particle packing, insulation, compressive strength and resiliency.

In some embodiments, the lightweight particle compositions 100, 200, 300, 500, 700 can comprise biomass particles (e.g., the lightweight particles 102, 104, 202, 204, 400, 502-518, 604, 606, 702, etc.) with an angular or subangular shape with an average size within a range from about 0.01 mm to about 20 mm with an average bulk density within a range from about 4 pcf to about 50 pcf. Such a composition can provide excellent weight savings, FR performance, particle packing, insulation, compressive strength and resiliency.

In some embodiments, the lightweight particle compositions 100, 200, 300, 500, 700 can comprise alumina particles (e.g., the lightweight particles 102, 104, 202, 204, 400, 502-518, 604, 606, 702, etc.) in crystalline shape with an average size within a range from about 0.001 mm to about 2 mm with an average bulk density within a range from about 20 pcf to about 80 pcf. Such a composition can provide excellent weight savings, FR performance, particle packing, insulation, compressive strength and resiliency.

In some embodiments, the lightweight particle compositions 100, 200, 300, 500, 700 can comprise alumina particles (e.g., the lightweight particles 102, 104, 202, 204, 400, 502-518, 604, 606, 702, etc.) in round or sub-round shape with an average size within a range from about 0.001 mm to about 6 mm with an average bulk density within a range from about 30 pcf to about 70 pcf. Such a composition can provide excellent weight savings, FR performance, particle packing, insulation, compressive strength and resiliency.

In some embodiments, the lightweight particle compositions 100, 200, 300, 500, 700 can comprise ceramic particles (e.g., the lightweight particles 102, 104, 202, 204, 400, 502-518, 604, 606, 702, etc.) in round or sub-round shape with an average size within a range from about 0.01 mm to about 6 mm with an average bulk density within a range from about 20 pcf to about 80 pcf. Such a composition can provide excellent weight savings, FR performance, particle packing, insulation, compressive strength and resiliency.

In some embodiments, the lightweight particle compositions 100, 200, 300, 500, 700 can comprise LDPE particles (e.g., the lightweight particles 102, 104, 202, 204, 400, 502-518, 604, 606, 702, etc.) with pancake shape with an average size within a range from about 3 mm to about 5 mm with a bulk density within a range from about 20 pcf to about 50 pcf. Such a combination can provide weight savings while still providing superb rigidity and strength.

As used herein, the term “about” means that amounts, sizes, formulations, parameters, and other quantities and characteristics are not, and need not be, exact, but may be approximate and/or larger or smaller, as desired, reflecting tolerances, conversion factors, rounding off, measurement error and the like, and other factors known to those of skill in the art.

Ranges can be expressed herein as from “about” one value, and/or to “about” another value. When such a range is expressed, another embodiment includes from the one value to the other value. Similarly, when values are expressed as approximations by use of the antecedent “about,” it will be understood that the value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including”, and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to represent that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It should be understood that while various embodiments have been described in detail relative to certain illustrative and specific examples thereof, the present disclosure should not be considered limited to such, as numerous modifications and combinations of the disclosed features are possible without departing from the scope of the following claims.

1. A lightweight particle composition comprising:
a plurality of lightweight particles that are one of enclosed, loose, or bonded, the plurality of lightweight particles comprising one of an inorganic or organic composition comprising:
a bulk density within a range from about 0.001 g/cc to about 1.5 g/cc;
a particle size within a range from about 0.01 microns to about 90 millimeters (mm);
wherein an interstitial void space between the plurality of lightweight particles comprises a total of less than about 70% of a volume of the plurality of lightweight particles.

2. The lightweight particle composition of claim 1, wherein the plurality of lightweight particles are modified or treated with one or more of a coating, a shell, or a substantially continuous outer layer.

3. The lightweight particle composition of claim 2, wherein a treatment applied to the plurality of lightweight particles comprises a thickness within a range from about 0.001 mm to about 1 mm.

4. The lightweight particle composition of claim 3, wherein the plurality of lightweight particles are coated with or incorporated into one or more of a resin, epoxy, urethane, polyurea, polyester, silicone, elastomeric, styrene-acrylic emulsion, styrene-butadiene emulsion, acrylic emulsion, latex emulsion, silane, siloxane, mineral, chemicals, fibers, graphene, powders, stearates, silicates, pigments, ethylene vinyl acetate, vinyl alcohol copolymer, vinyl acrylic emulsion polymer, acrylic copolymer, oleoresinous vehicles, cement gypsum, or pozzolans.

5. The lightweight particle composition of claim 1, wherein the plurality of lightweight particles comprise one or more of an expanded, extruded, molded, formed, pressed, shredded, chopped, harvested, mined, milled, printed, reacted, fused, stamped, die-cut, or recycled material.

6. The lightweight particle composition of claim 1, wherein the plurality of lightweight particles comprise one or more of a base or a modified polyolefin, polystyrene, nylon, ABS, LDPE, HDPE, PVC, PVDC, acrylic, acrylonitrile based copolymer, agricultural biomass base material, a carbon material, graphene, a ceramic material, a silica aerogel material, an alumina material, copolymer and alloy systems, microspheres, rubber, an EPDM material, a polyamide, PET, PMMA, PMU, melamine, urea formaldehyde, polyvinylidene dichloride, hemp, sisal, rice hulls, oat hulls, ground corncobs, walnut shells, or a wood material.

7. The lightweight particle composition of claim 1, wherein the plurality of lightweight particles comprise one or more of glass, foamed glass, mineral, ceramic, carbon, graphite, alumina, oxides, graphene, agricultural byproduct, biomass, rubber, synthetic or recycled materials.

8. The lightweight particle composition of claim 1, wherein the plurality of lightweight particles comprise one or more of polymer pellets, polymer foam beads, crushed glass, foamed glass spheres, hollow glass microspheres, polymer microspheres, polymer capsules, polymer micro-balloons, or carbon-based pellets.

9. The lightweight particle composition of claim 1, further comprising a container or space comprising one or more walls that define an enclosed chamber, wherein the container comprises one or more of a bag, float, box, drum, tank, or a void within a wall, floor, ceiling, cavity, structure, or equipment housing.

10. The lightweight particle composition of claim 1, wherein the plurality of lightweight particles comprises one or more of a rounded shape, a round shape, a sub-round shape, an angular shape, a sub-angular shape, a cylindrical shape, a pancake shape, an oblong shape, a trilobal shape, a tubular shape, a polygonal shape, a disc shape, a shard shape, a platelet shape, a lamellar shape, a regular crystalline shape, or an irregular crystalline shape.

11. A lightweight particle composition comprising:
a plurality of lightweight particles comprising a bulk density within a range from about 0.001 g/cc to about 1.5 g/cc, and a particle size within a range from about 0.01 microns to about 90 millimeters (mm), the plurality of lightweight particles comprising one of:
an inorganic material;
an organic material; or
a first portion of the plurality of lightweight particles comprising an inorganic material and a second portion of the plurality of lightweight particles comprising an organic material;
the plurality of lightweight particles comprising one of;
a porous material;
a non-porous material; or
a third portion of the plurality of lightweight particles comprising a porous material and a fourth portion of the plurality of lightweight particles comprising a non-porous material;
wherein the plurality of lightweight particles comprise one or more of a coating, treatment, or modification incorporated into or applied to a surface or as part of a system of the plurality of lightweight particles that at least partially surrounds each of the plurality of lightweight particles, the coating comprising a thickness within a range from about 0.001 mm to about 1 mm, further wherein the coating is applied at a ratio of about 0.001% to about 50% by weight.

12. A method of manufacturing a lightweight particle composition comprising:
selecting a plurality of lightweight particles comprising a bulk density that is within a range from about 0.001 g/cc to about 1.5 g/cc, and a particle size is within a range from about 0.01 microns to about 90 millimeters (mm), the plurality of lightweight particles comprising one of:
an inorganic material;
an organic material; or
a first portion of the plurality of lightweight particles comprising an inorganic material and a second portion of the plurality of lightweight particles comprising an organic material;
the plurality of lightweight particles comprising one of;
a porous material;
a non-porous material; or
a third portion of the plurality of lightweight particles comprising a porous material and a fourth portion of the plurality of lightweight particles comprising a non-porous material; and
positioning the plurality of lightweight particles within a space such that an interstitial void space between the plurality of lightweight particles comprises a total of less than about 70% of a volume of the plurality of lightweight particles.

13. The method of claim 12, further comprising applying one or more of a coating, treatment, or modification to the plurality of lightweight particles.

14. The method of claim 12, further comprising using the particles as an additive into a formulated system.

15. The method of claim 12, further comprising applying one or more of a treatment, a modification, or a coating to the plurality of lightweight particles such that the plurality of lightweight particles comprise one or more of fire resistance, fire suppressant, anti-static, conductive, anti-microbial, anti-bacterial, anti-vermin, electronic tracker enabled, carrier for fertilizers, algicides, insecticides, weed killers, color, die or pigment, scent-modified, perfume-modified, flavor-modified, or reactance to one of more of temperature, pH, gases, chemicals, liquids, particles, infrared, dissolvable, infrared modified, magnetized, or electronic.

16. The method of claim 15, wherein the treatment, modification, or coating triggers or involves a release in the presence of an activation event or catalyzation event, wherein the activation event or catalyzation event comprises one or more of a petrochemical, peroxide, acid, base, temperature, chemical initiator, moisture, air oxidation, ultraviolet light, microwave, other radiation, pressure, force, or time at a time of manufacture, application, or later time to suit the conditions of use.

17. The method of claim 12, wherein the plurality of lightweight particles are selected to achieve one or more of a weight reduction, a cost reduction, or filling of a void without a loss of one or more of performance or appearance, further wherein an R-value of the lightweight particle composition is within a range from about 0.1 to about 5, further wherein the plurality of lightweight particles are coated with or incorporated into one or more of a resin, epoxy, urethane, polyurea, polyester, silicone, elastomeric, styrene-acrylic emulsion, styrene-butadiene emulsion, acrylic emulsion, latex emulsion, silane, siloxane, mineral, chemicals, fibers, graphene, powders, stearates, silicates, pigments, ethylene vinyl acetate, vinyl alcohol copolymer, vinyl acrylic emulsion polymer, acrylic copolymer, oleoresinous vehicles, cement, gypsum, or pozzolans.

18. The method of claim 12, further comprising mixing the plurality of lightweight particles with one or more of suspension agents, surfactants, functional chemicals, curing agents, dispersants, admixtures, or rheology modifiers.

19. The method of claim 12, wherein the space comprises an enclosed chamber within a container such that the plurality of lightweight particles are located within the container.

20. The method of claim 12, wherein the space comprises an open space such that the plurality of lightweight particles are used as carriers or loose-fill particles.
